(19) United States
(12) Patent Application Publication
(10) Pub. No.: US 2015/0204064 A1
(43) Pub. Date: Jul. 23, 2015

(54) INSULATED FRAMING MEMBER

(71) Applicant: E I DU PONT DE NEMOURS AND COMPANY, Wilmington, DE (US)

(72) Inventors: Wazir Nobbee, Chesterfield, VA (US); Christopher E. Fetterman, Richmond, VA (US)

(21) Appl. No.: 14/596,299

(22) Filed: Jan. 14, 2015

Related U.S. Application Data
(60) Provisional application No. 61/928,628, filed on Jan. 17, 2014.

(51) Int. Cl. E04B 1/78; B32B 21/04; E04B 1/62; B32B 5/18

(52) U.S. Cl. CPC E04B 1/78; B32B 5/18; B32B 21/047; E04B 1/62; B32B 2307/304; B32B 2607/00; E04B 2001/745

(57) ABSTRACT

An insulated framing member for exterior wall insulation, and a method for covering walls with insulation materials using the insulated framing member underneath a water or weather-resistant barrier. The insulated framing member comprises a strip of insulating foam having chamfers along the edges, laminated to a wooden nailable substrate. The insulated framing member will reduce the compression of compressible insulation materials, the thermal bridging of fasteners, and eliminate water entrapment.

### CROSS REFERENCE TO RELATED APPLICATION

This application claims priority to U.S. Provisional application No. 61/928,628, filed Jan. 17, 2014.

### FIELD OF THE INVENTION

The present invention relates to an insulated framing member for exterior wall insulation installation, and to a method for covering walls using the insulated framing member.

### BACKGROUND OF THE INVENTION

Each revision of the International Residential Code (IRC) tends to increase the energy requirements specified therein. The 2012 revision of the IRC requires more insulation, a tighter building envelope, tighter ducts, better windows, and more efficient lighting than the 2009 code. Wall insulation requirements have become more stringent in climate zones 3, 4, 6, 7, and 8; for the first time, builders in climate zones 6, 7, and 8 will be required to install exterior rigid foam insulation, or to use some other comparable wall insulation strategy. Every new home built to meet the higher standards of the 2012 IRC will need to develop a strategy to prevent thermal bridging through structural members. Standard wood furring strips are currently used to provide enhanced drainage behind exterior claddings. Standard wood furring strips have low thermal resistance which is problematic in meeting the higher standards of the 2012 IRC. Additionally, furring strips reduce the R-value of conventional compressible insulation materials when they are installed over the insulation materials and reduce the entrapped air. There is a need for means to prevent thermal bridging, and increase R-value, in building envelopes. Additionally, there is a need for means to prevent thermal bridging, and increase R-value, in building envelopes that does not trap water.

### SUMMARY OF THE INVENTION

An embodiment of the invention is an insulated framing member comprising an elongate wooden strip with a rectangular cross sectional profile which has a front side and a backside, a strip of rigid insulating foam having the cross sectional profile of an isosceles trapezoid with a long base and a short base, the short base of the strip of insulating foam is laminated on the backside of said elongate wooden strip.

### DEFINITIONS

The term “furring strip” is used herein to refer to an elongate strip of wood or metal fixed to a wall, floor, or ceiling to provide a surface for the fixing of building materials such as weather resistant barrier, cladding, etc.

The term “building code” is used herein to refer to a series of ordinances enacted by a state or local governmental entity, establishing minimum requirements that must be met in the construction and maintenance of buildings.

The term “building envelope” is used herein to refer to a system or assembly of exterior wall components, including exterior wall finish materials, that provide protection of the building structural members, including framing and sheathing materials, and conditioned interior space, from the detrimental effects of the exterior environment.

The term “cladding” is used herein to refer to any material that constitutes the exposed, non-load bearing, exterior covering of an exterior wall. Such material is applied over any sheathing that is present, or otherwise is directly attached to the building envelope as the outermost component of the wall system.

The term “wall studs” is used herein to refer to the any of the stick-like parts that form the vertical structural framework of a wall. Wall studs may be load-bearing or nonload-bearing.

The term “water-resistive barrier” is used herein to refer to a material that is intended to resist liquid water that has penetrated behind the cladding from further intruding into the exterior wall assembly. The water-resistive barrier is placed on the interior side of the cladding.

The term “weather-resistive barrier” is used herein to refer to a material that is intended to resist both liquid water and air that has penetrated behind the cladding from further intruding into the exterior wall assembly. The weather-resistive barrier is placed on the interior side of the cladding.

The term “WRB” is used herein to refer to either a water-resistive barrier or a weather-resistive barrier, which are used for analogous purposes in residential and commercial, respectively, construction.

The term “isosceles trapezoid” is used herein to refer to a quadrilateral having two opposite sides of unequal length (the long bases and the short base) which are parallel, and the two other sides (the legs) that are of equal length. The base angles of an isosceles trapezoid are equal in measure and the opposite base angle is the supplementary angle of a base angle at the other base.

### BRIEF DESCRIPTION OF THE DRAWINGS

FIG. 1 depicts a view of an insulated framing member.

FIG. 2 depicts a view of insulated framing member installed in a wall.

FIG. 3A and FIG. 3B depict views of various means for installing an insulated framing member in a wall.

FIG. 4A and FIG. 4B depict cutaway views of various means for installing an insulated framing member in a wall.

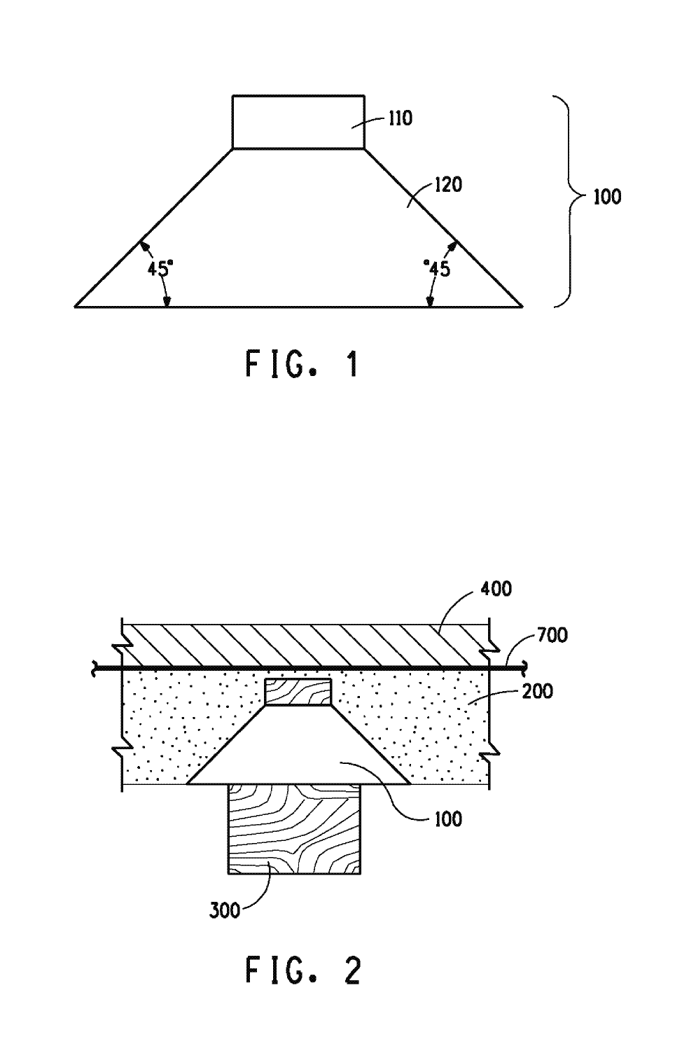

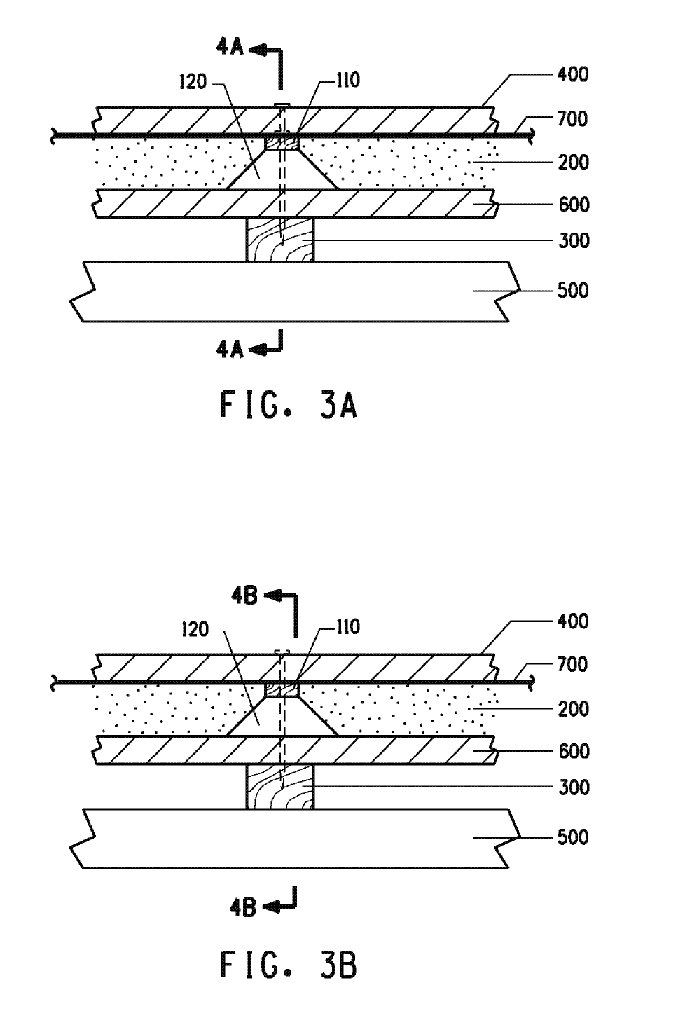

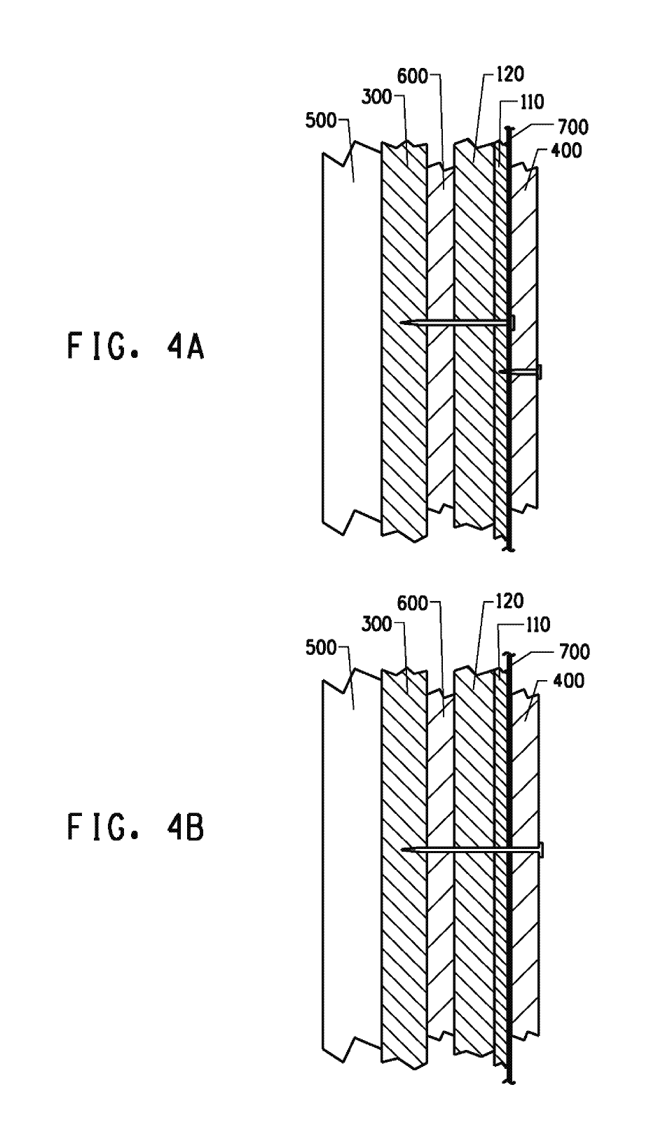

### DETAILED DESCRIPTION

The 2012 IRC building code requires additional wall insulation, which will alter typical building practices. The present invention will be used with conventional compressible insulation materials such as, but not limited to, mineral wool, fiberglass, cotton, cellulose, and vermiculite. The present invention is especially useful for use with any thermally insulating batt that contains staple fibers that pack together in an open or loose manner. Standard wood furring strips are currently used to provide enhanced drainage behind exterior claddings but their low R-Value is problematic in meeting the energy requirements of the 2012 IRC. Wood furring strips are also problematic in that they compress the insulation material. It is found that when a furring strip is installed over insulation materials they are compressed down to approximately ¼″ in thickness. Insulation materials depend on entrapped air space to provide insulation properties. Compression will reduce the entrapped air space, increase density, and result in a lower R-Value. The insulated framing member 100 of the present invention will achieve an acceptable R-Value as the conventional compressible insulation materials are compressed to an extent that does not reduce the R-value of the insulation material below that required to meet the budding code requirement, which is summarized in Table 1. The insulated framing member of Table 1 was comprised of a ⅝ inch plywood portion laminated to a ⅞ inch foam portion.

### R-Value Comparison of Insulated Framing Member and Traditional Wood Furring Strip

TABLE 1

| | R-Value of | R-Value of | |
|---|---|---|---|
| | Foam | wood | Total R-value |
| 1½″ insulated | 3.78 | 0.75 | 4.53 |
| Framing Member | | | |
| 1½″ Wood | N/A | 2.31 | 2.31 |
| Furring Strip | | | |

In addition to providing thermal insulation, the insulated framing member 100 will reduce the thermal bridging of fasteners used to fasten the insulated framing member to a wall in comparison to furring strips.

In response to the increased requirements of the 2012 IRC there is a trend to add additional insulation to the exterior of buildings, such as windows and door surrounds. In another embodiment of the invention, the insulated framing member can provide additional insulation around windows, doors or any penetration.

The instant invention uses an insulated batten underneath conventional compressible insulation materials to provide a nailable substrate with the necessary thermal resistance when the conventional insulation materials are compressed. Additionally, the placement of the insulated batten underneath the insulation material will eliminate the potential of water entrapment between a batten and a WRB 700 as compared to when the batten is installed on the exterior of the WRB 700. The insulated batten 100 is comprised of a strip of wooden material 110 laminated to a strip of rigid foam 120. A profile is cut on each side of the insulated batten to match the gradual compression of conventional compressible insulation materials. The wooden portion of the batten is used as a nailable substrate 110 to secure the compressible insulating material 200.

The insulated framing member of the present invention 100 will consist of a rigid foam strip 120 having a chamfer on each edge. The elongate rigid foam strip 120 of the insulated framing member has the profile of an isosceles trapezoid. The angle between the long base and the legs functions to reduce the compression of conventional insulation materials along with which the insulated framing member is installed. Optionally, the chamfers of the rigid foam strip 120 may be arcuate. Rigid foam 120 provides necessary thermal resistance to the wall where conventional compressible insulation materials 200 are compressed. Foam materials that may be used include polyisocyanurates polyurethanes, extruded polystyrene, expanded polystyrene, tannic foams, phenolic foams, biophenolics foams, and combinations thereof.

The insulated framing member of the present invention 100 also consists of an elongated wooden portion that serves as a nailable substrate 110 for fastening exterior cladding. Wooden materials that may be used include oriented strand board (OSB), various densities of fiberboard such as MDF, pine, spruce, fir, plywood, and combinations thereof. Plywood is the preferred wooden portion. The wooden portion may, optionally, be pressure treated for improved resistance to insects, microorganisms and fungal decay. The nailable substrate 110 has the profile of a rectangle having a front side, a backside, and a first edge and a second edge.

The backside of wooden strip 110 is laminated to the short base of foam strip 120. The lamination may use any conventional lamination process. The adhesive may be any applicable adhesive that is compatible with foams and wood.

The thickness of the insulated batten 100 plays a critical role. In terms of thickness, a properly designed insulated batten will provide an air space between the WRB 700 and the exterior cladding for enhanced drainage and drying for any moisture that may get behind the cladding. Although there is no limitation to the dimensions of the insulated framing member, it is illustrative to discuss them in a size comparable to a standard furring strip. Illustratively, the insulated framing member 100 will be approximately 2½″×1½″×48″.

### EXAMPLES

### Comparative Example 1

Typical wooden furring strips were fastened onto a wall overtop of a compressible insulation that was covered by a water-resistive barrier. Since the insulation and water-resistive barrier were compressed, the thermal resistance (R-value) was reduced.

### Example 1

Rigid insulation was laminated to the back of wood furring strips. Chamfers were cut on each side of the rigid insulation to form insulated framing members. Insulated framing members were fastened onto a wall overtop of a compressible insulation that was covered by a water-resistive barrier. The chamfers reduced the gradual compression of the insulation and water-resistive barrier product. This provided the necessary thermal resistance to the wall where the insulation was compressed in Comparative Example 1.The wooden portion of the insulated framing member was used as a fastener base for the exterior cladding. This provided a benefit since the cladding fastener did not penetrate the water-resistive barrier (WRB) and thus reduced the possibility of air and water infiltration.

What is claimed is:

1. An insulated framing member comprising an elongate wooden strip with a rectangular cross sectional profile having a front side and a backside, a strip of rigid insulating foam having the cross sectional profile of an isosceles trapezoid with a long base and a short base, the short base of the ship of insulating foam is laminated on the backside of said elongate wooden strip.
